(19) United States
(12) Patent Application Publication
(10) Pub. No.: US 2014/0080084 A1
(43) Pub. Date: Mar. 20, 2014

(54) CYCLIC INTERRUPTIVE FORCE ORTHODONTIC DEVICE AND SYSTEM

(71) Applicant: B. Chia Soo, Beverly Hills, CA (US)

(72) Inventor: B. Chia Soo, Beverly Hills, CA (US)

(73) Assignee: THE REGENTS OF THE UNIVERSITY OF CALIFORNIA, Oakland, CA (US)

(21) Appl. No.: 13/702,579

(22) PCT Filed: Jun. 6, 2011
(86) PCT No.: PCT/US11/01036

§ 371 Date: May 13, 2013

Related U.S. Application Data
(60) Provisional application No. 61/352,290, filed on Jun. 7, 2010.

(51) Int. Cl. A61C 7/10

(52) U.S. Cl. CPC A61C 7/10
USPC 433/7; 433/24

(57) ABSTRACT

Provided herein is a cyclic interruptive force orthodontic device and a system comprising the same. Methods of making and using the same are also provided.

### FIELD OF THE INVENTION

The present invention is related generally to the field of orthodontics.

### BACKGROUND OF THE INVENTION

Conventional method of repositioning teeth is to make users wear what are commonly referred to as “braces.” Braces include a variety of appliances such as brackets, archwires, ligatures, and O-rings, which provide static aligning forces. The procedures of conventional orthodontics are briefly described here: Before fastening braces to a user's teeth, at least one appointment is typically scheduled with the orthodontist, dentist, and/or X-ray laboratory so that X-rays and photographs of the user's teeth and jaw structure can be taken. Also during this preliminary meeting, or possibly at a later meeting, an alginate mold of the user's teeth is typically made. This mold provides a model of the user's teeth that the orthodontist uses in conjunction with the X-rays and photographs to formulate a treatment strategy. The orthodontist then typically schedules one or more appointments during which braces will be attached to the user's teeth.

At the meeting during which braces are first attached, the teeth surfaces are initially treated with a weak acid the acid optimizes the adhesion properties of the teeth surfaces for brackets and bands that are to be bonded to them. The brackets and bands serve as anchors for other appliances to be added later. After the acid step, the brackets and bands are cemented to the user's teeth using a suitable bonding material. No force-inducing appliances are added until the cement is set. For this reason, it is common for the orthodontist to schedule a later appointment to ensure that the brackets and bands are well bonded to the teeth.

The primary force-inducing appliance in a conventional set of braces is the archwire. The archwire is resilient and is attached to the brackets by way of slots in the brackets. The archwire links the brackets together and exerts forces on them to move the teeth over time. Twisted wires or elastomeric O-rings are commonly used to reinforce attachment of the archwire to the brackets. Attachment of the archwire to the brackets is known in the art of orthodontia as “ligation” and wires used in this procedure are called “ligatures.” The elastomeric O-rings are called “plastics.”

After the archwire is in place, periodic meetings with the orthodontist are required, during which the user's braces will be adjusted by installing a different archwire having different force inducing properties or by replacing or tightening existing ligatures. Typically, these meetings are scheduled every three to six weeks.

Problems exist in the conventional static force orthodontic technologies. Such problems include, e.g., patient discomfort, lack of effective hygiene means in the oral cavity leading to oral or periodontal infections, being aesthetically unappealing, and long duration of orthodontic treatment, to name a few.

To address some problems associated with static force orthodontic systems and methods, Mao proposed a cyclic interruptive force orthodontic device and method for orthodontic treatment with limited success (U.S. Pat. Nos. 6,648,639 and 6,832,912).

Another approach is the OrthoAccel™ device, which provides low frequency vibrations purportedly to enhance bone metabolism so as to facilitate orthodontic treatment. However, the OrthoAccel™ device is ineffective since it is incapable of directional control over forces, the vibration caused by such devices bears no correlation with orthodontic force vectors, and force magnitude varies with patient biting forces.

The embodiments described below address the above identified needs and issues.

### SUMMARY OF THE INVENTION

In one aspect of the present invention, it is provided a cyclic interruptive force orthodontic device for repositioning teeth from an initial arrangement to a final arrangement, comprising:

a base having a geometry selected to generate orthodontic force vectors to progressively reposition the teeth from the initial arrangement to an intermediate arrangement or the final arrangement,

a spring or an elastic band attached to the base,

at least one motor attached to the spring or the elastic band, and

an actuator, which is a stand-alone actuator or included in the motor,

wherein the spring or elastic band generates an orthodontic force,

wherein the motor and the actuator are capable of communication such that the actuator is capable of causing the motor to generate a cyclic interruptive force on at least one tooth in which tooth alignment is desired to facilitate movement of the tooth; and

wherein the cyclic interruptive force is co-linear or substantially co-linear with the orthodontic force vectors.

In some embodiments, optionally in combination with any or all the various embodiments disclosed herein, the actuator can be a micropiezo actuator or a regulator motor. In some embodiments, optionally in combination with any or all the various embodiments disclosed herein, the actuator is a micropiezo actuator capable of:

generating a pulling force up to 5 N,

generating a pushing force up to 1,000N,

generating a strain range of about 60 μm, and

having a response time about 1 msec. or less.

In some embodiments, optionally in combination with any or all the various embodiments disclosed herein, the micropiezo actuator has a resolution about 1 nm or less.

In some embodiments, optionally in combination with any or all the various embodiments disclosed herein, the actuator comprises a microprocessor, which allows the cyclic interruptive force orthodontic device to generate a cyclic interruptive force to cause the tooth to move at a prescribed amount of alignment.

In some embodiments, optionally in combination with any or all the various embodiments disclosed herein, the cyclic interruptive force orthodontic device is removable.

The frequency and magnitude of the cyclic interruptive force generated by the cyclic interruptive orthodontic device disclosed herein are such that the force vibration is outside the range for human hearing via bone conduction (for night time wear). In some embodiments, such interruptive force can have vibrations of frequency and magnitude that can be inside the human hearing range for day time wear.

In some embodiments, optionally in combination with any or all the various embodiments disclosed herein, the cyclic interruptive force has a frequency of 0.1 Hz to 1000 Hz.

In some embodiments, optionally in combination with any or all the various embodiments disclosed herein, the net of the orthodontic force and the cyclic interruptive force has a maximum magnitude derived by the spring, and the minimum force magnitude is controlled by spring minus the force of the motor. In some embodiments, the cyclic interruptive force has a maximum force magnitude from about 0.1 N to about 1000 N, from about 0.1 N to about 500 N, from about 0.1 N to about 100 N, from about 0.1 N to about 50 N, from about 0.1 N to about 10 N, from about 0.1 N to about 5 N, from about 0.1 N to about 4 N, from about 0.1 N to about 3 N, from about 0.1 N to about 2 N, or from 0.1 N to about 1 N.

In some embodiments, the cyclic interruptive force has a maximum force magnitude from about 1 N to about 1000 N, from about 1 N to about 500 N, from about 1 N to about 100 N, from about 1 N to about 50 N, from about 1 N to about 10 N, from about 1 N to about 5 N, from about 1 N to about 4 N, from about 1 N to about 3 N, or from about 1 N to about 2 N.

In some embodiments, the cyclic interruptive force has a maximum force magnitude from about 2 N to about 1000 N, from about 2 N to about 500 N, from about 2 N to about 100 N, from about 2 N to about 50 N, from about 2 N to about 10 N, from about 2 N to about 5 N, from about 2 N to about 4 N, or from about 2 N to about 3 N.

In some embodiments, the cyclic interruptive force has a maximum force magnitude from about 3 N to about 1000 N, from about 3 N to about 500 N, from about 3 N to about 100 N, from about 3 N to about 50 N, from about 3 N to about 10 N, from about 3 N to about 5 N, or from about 3 N to about 4 N.

In some embodiments, the cyclic interruptive force has a maximum force magnitude from about 4 N to about 1000 N, from about 4 N to about 500 N, from about 4 N to about 100 N, from about 4 N to about 50 N, from about 4 N to about 10 N, or from about 4 N to about 5 N.

In some embodiments, the cyclic interruptive force has a maximum force magnitude from about 5 N to about 1000 N, from about 5 N to about 500 N, from about 5 N to about 100 N, from about 5 N to about 50 N, or from about 5 N to about 10 N.

In some embodiments, the cyclic interruptive force has a maximum force magnitude from about 10 N to about 1000 N, from about 10 N to about 500 N, from about 10 N to about 100 N, or from about 10 N to about 50 N.

In some embodiments, the cyclic interruptive force has a maximum force magnitude from above about 10 N to about 1000 N, from above about 10 N to about 500 N, from above about 10 N to about 100 N, or from above about 10 N to about 50 N.

In some embodiments, optionally in combination with any or all the various embodiments disclosed herein, the cyclic interruptive force has a frequency of above 40 Hz or of 0.1 Hz to 40 Hz.

In another aspect of the present invention, it is provided an orthodontic system, comprising

at least one cyclic interruptive force orthodontic device according and at least one static force appliances,

wherein the cyclic interruptive force orthodontic device comprises:
a base having a geometry selected to generate orthodontic force vectors to progressively reposition the teeth from the initial arrangement to an intermediate arrangement or the final arrangement,
a spring or an elastic band attached to the base,
at least one motor attached to the spring or the elastic band, and
an actuator, which is a stand-alone actuator or included in the motor,
wherein the spring or elastic band generates an orthodontic force,
wherein the motor and the actuator are capable of communication such that the actuator is capable of causing the motor to generate a cyclic interruptive force on at least one tooth in which tooth alignment is desired to facilitate movement of the tooth; and
wherein the cyclic interruptive force is co-linear or substantially co-linear with the orthodontic force vectors; and

wherein the static force appliance holds the teeth in the intermediate arrangement or the final arrangement.

In some embodiments, optionally in combination with any or all the various embodiments disclosed herein, the actuator is a micropiezo actuator. In some embodiments, optionally in combination with any or all the various embodiments disclosed herein, the micropiezo actuator is capable of:

generating a pulling force up to 5 N,

generating a pushing force up to 1,000N,

generating a strain range of about 60 μm, and

having a response time about 1 msec. or less.

In some embodiments, optionally in combination with any or all the various embodiments disclosed herein, the micropiezo actuator has a resolution about 1 nm or less.

In some embodiments, optionally in combination with any or all the various embodiments disclosed herein, the actuator comprises a microprocessor, which allows the cyclic interruptive force orthodontic device to generate a cyclic interruptive force to cause the tooth to move at a prescribed amount of alignment.

In some embodiments, optionally in combination with any or all the various embodiments disclosed herein, the cyclic interruptive force orthodontic device and static appliance are removable.

The frequency and magnitude of the cyclic interruptive force generated by the cyclic interruptive orthodontic device disclosed herein are such that the force vibration is outside the range for human hearing via bone conduction (for night time wear). In some embodiments, such interruptive force can have vibrations of frequency and magnitude that can be inside the human hearing range for day time wear.

In some embodiments, optionally in combination with any or all the various embodiments disclosed herein, the cyclic interruptive force has a frequency of 0.1 Hz to 1000 Hz.

In some embodiments, optionally in combination with any or all the various embodiments disclosed herein, the net of the orthodontic force and the cyclic interruptive force has a maximum magnitude derived by the spring, and the minimum force magnitude is controlled by spring minus the force of the motor. In some embodiments, the cyclic interruptive force has a maximum force magnitude from about 0.1 N to about 1000 N, from about 0.1 N to about 500 N, from about 0.1 N to about 100 N, from about 0.1 N to about 50 N, from about 0.1 N to about 10 N, from about 0.1 N to about 5 N, from about 0.1 N to about 4 N, from about 0.1 N to about 3 N, from about 0.1 N to about 2 N, or from 0.1 N to about 1 N.

In some embodiments, the cyclic interruptive force has a maximum force magnitude from about 1 N to about 1000 N, from about 1 N to about 500 N, from about 1 N to about 100 N, from about 1 N to about 50 N, from about 1 N to about 10 N, from about 1 N to about 5 N, from about 1 N to about 4 N, from about 1 N to about 3 N, or from about 1 N to about 2 N.

In some embodiments, the cyclic interruptive force has a maximum force magnitude from about 2 N to about 1000 N, from about 2 N to about 500 N, from about 2 N to about 100 N, from about 2 N to about 50 N, from about 2 N to about 10 N, from about 2 N to about 5 N, from about 2 N to about 4 N, or from about 2 N to about 3 N.

In some embodiments, the cyclic interruptive force has a maximum force magnitude from about 3 N to about 1000 N, from about 3 N to about 500 N, from about 3 N to about 100 N, from about 3 N to about 50 N, from about 3 N to about 10 N, from about 3 N to about 5 N, or from about 3 N to about 4 N.

In some embodiments, the cyclic interruptive force has a maximum force magnitude from about 4 N to about 1000 N, from about 4 N to about 500 N, from about 4 N to about 100 N, from about 4 N to about 50 N, from about 4 N to about 10 N, or from about 4 N to about 5 N.

In some embodiments, the cyclic interruptive force has a maximum force magnitude from about 5 N to about 1000 N, from about 5 N to about 500 N, from about 5 N to about 100 N, from about 5 N to about 50 N, or from about 5 N to about 10 N.

In some embodiments, the cyclic interruptive force has a maximum force magnitude from about 10 N to about 1000 N, from about 10 N to about 500 N, from about 10 N to about 100 N, or from about 10 N to about 50 N.

In some embodiments, the cyclic interruptive force has a maximum force magnitude from above about 10 N to about 1000 N, from above about 10 N to about 500 N, from above about 10 N to about 100 N, or from above about 10 N to about 50 N.

In some embodiments, optionally in combination with any or all the various embodiments disclosed herein, the cyclic interruptive force has a frequency of above 40 Hz or a frequency of about 0.1 Hz to 40 Hz.

In a further aspect of the present invention, it is provided a method of aligning tooth in a subject, comprising:

applying cyclical forces to at least one tooth of the mammal in which tooth realignment is desired with a peak magnitude of about 0.1 to about 10 N and a frequency of about 0.1 to 1000 Hz in a direction of the desired realignment repeatedly for a period of time until a predetermined amount of tooth realignment is obtained,

applying a static force to hold the tooth in an aligned position when the cyclic interruptive forces are removed from the tooth.

In some embodiments, optionally in combination with any or all the various embodiments disclosed herein, the cyclic interruptive forces are repeatedly applied a plurality of times or continuously for a period each day.

In some embodiments, optionally in combination with any or all the various embodiments disclosed herein, the cyclic interruptive forces have a frequency of above 40 Hz to 1000 Hz or a frequency of about 0.1 Hz to 40 Hz.

In some embodiments, optionally in combination with any or all the various embodiments disclosed herein, the cyclic interruptive forces are repeatedly applied over a period of days or a period of months.

In some embodiments, optionally in combination with any or all the various embodiments disclosed herein, the peak magnitude is about 2 N.

In some embodiments, optionally in combination with any or all the various embodiments disclosed herein, the static force is applied by a plastic appliance.

In some embodiments, optionally in combination with any or all the various embodiments disclosed herein, the cyclic interruptive force is generated by a cyclic aligner according to any of the various embodiments disclosed herein.

In some embodiments, optionally in combination with any or all the various embodiments disclosed herein, the predetermined amount of tooth realignment and the aligned position are an intermediate tooth arrangement or a final tooth arrangement.

In some embodiments, optionally in combination with any or all the various embodiments disclosed herein, the tooth has a disorder selected from malalignment, crowding, spacing, overjet, overbite problem, and a combination thereof.

In another aspect of the present invention, it is provided a method of fabricating a cyclic interruptive force orthodontic device for repositioning teeth from an initial arrangement to a final arrangement. The device is according to the various embodiments disclosed herein.

In another aspect of the present invention, it is provided a method of fabricating for repositioning teeth from an initial arrangement to a final arrangement comprising a system comprising a cyclic interruptive force orthodontic device and a static force appliance, The system is as the various embodiments disclosed herein.

### BRIEF DESCRIPTION OF THE DRAWINGS

FIG. 1 shows several exemplary conventional orthodontic devices (also described as aligners) commonly known in the art, namely, mini-expansion screw aligners, Bloore aligners, spring loaded microscrew aligners, 2-way saggital aligners, and 3-way saggital aligners.

FIG. 2 shows examples of conventional Inman spring aligners.

FIG. 3 shows some examples of conventional invisible orthodontic aligners.

FIG. 4 shows some further examples of conventional invisible aligners.

FIG. 5 shows an embodiment of the cyclic interruptive force orthodontic device of invention.

FIG. 6 shows a few examples of actuators for the cyclic interruptive force orthodontic device of invention.

### DESCRIPTION OF DETAILED INVENTION

In one aspect of the present invention, it is provided a cyclic interruptive force orthodontic device for repositioning teeth from an initial arrangement to a final arrangement, comprising:

a base having a geometry selected to generate orthodontic force vectors to progressively reposition the teeth from the initial arrangement to an intermediate arrangement or the final arrangement,

a spring or an elastic band attached to the base,

at least one motor attached to the spring or the elastic band, and

an actuator, which is a stand-alone actuator or included in the motor,

wherein the spring or elastic band generates an orthodontic force,

wherein the motor and the actuator are capable of communication such that the actuator is capable of causing the motor to generate a cyclic interruptive force on at least one tooth in which tooth alignment is desired to facilitate movement of the tooth; and

wherein the cyclic interruptive force is co-linear or substantially co-linear with the orthodontic force vectors.

In some embodiments, optionally in combination with any or all the various embodiments disclosed herein, the actuator can be a micropiezo actuator or a regulator motor. In some embodiments, optionally in combination with any or all the various embodiments disclosed herein, the actuator is a micropiezo actuator capable of:

generating a pulling force up to 5 N,

generating a pushing force up to 1,000N,

generating a strain range of about 60 μm, and

having a response time about 1 msec. or less.

In some embodiments, optionally in combination with any or all the various embodiments disclosed herein, the micropiezo actuator has a resolution about 1 nm or less.

In some embodiments, optionally in combination with any or all the various embodiments disclosed herein, the actuator comprises a microprocessor, which allows the cyclic interruptive force orthodontic device to generate a cyclic interruptive force to cause the tooth to move at a prescribed amount of alignment.

In some embodiments, optionally in combination with any or all the various embodiments disclosed herein, the cyclic interruptive force orthodontic device is removable.

The frequency and magnitude of the cyclic interruptive force generated by the cyclic interruptive orthodontic device disclosed herein are such that the force vibration is outside the range for human hearing via bone conduction (for night time wear). In some embodiments, such interruptive force can have vibrations of frequency and magnitude that can be inside the human hearing range for day time wear.

In some embodiments, optionally in combination with any or all the various embodiments disclosed herein, the cyclic interruptive force has a frequency of 0.1 Hz to 1000 Hz.

In some embodiments, optionally in combination with any or all the various embodiments disclosed herein, the net of the orthodontic force and the cyclic interruptive force has a maximum magnitude derived by the spring, and the minimum force magnitude is controlled by spring minus the force of the motor. In some embodiments, the cyclic interruptive force has a maximum force magnitude from about 0.1 N to about 1000 N, from about 0.1 N to about 500 N, from about 0.1 N to about 100 N, from about 0.1 N to about 50 N, from about 0.1 N to about 10 N, from about 0.1 N to about 5 N, from about 0.1 N to about 4 N, from about 0.1 N to about 3 N, from about 0.1 N to about 2 N, or from 0.1 N to about 1 N.

In some embodiments, the cyclic interruptive force has a maximum force magnitude from about 1 N to about 1000 N, from about 1 N to about 500 N, from about 1 N to about 100 N, from about 1 N to about 50 N, from about 1 N to about 10 N, from about 1 N to about 5 N, from about 1 N to about 4 N, from about 1 N to about 3 N, or from about 1 N to about 2 N.

In some embodiments, the cyclic interruptive force has a maximum force magnitude from about 2 N to about 1000 N, from about 2 N to about 500 N, from about 2 N to about 100 N, from about 2 N to about 50 N, from about 2 N to about 10 N, from about 2 N to about 5 N, from about 2 N to about 4 N, or from about 2 N to about 3 N.

In some embodiments, the cyclic interruptive force has a maximum force magnitude from about 3 N to about 1000 N, from about 3 N to about 500 N, from about 3 N to about 100 N, from about 3 N to about 50 N, from about 3 N to about 10 N, from about 3 N to about 5 N, or from about 3 N to about 4 N.

In some embodiments, the cyclic interruptive force has a maximum force magnitude from about 4 N to about 1000 N, from about 4 N to about 500 N, from about 4 N to about 100 N, from about 4 N to about 50 N, from about 4 N to about 10 N, or from about 4 N to about 5 N.

In some embodiments, the cyclic interruptive force has a maximum force magnitude from about 5 N to about 1000 N, from about 5 N to about 500 N, from about 5 N to about 100 N, from about 5 N to about 50 N, or from about 5 N to about 10 N.

In some embodiments, the cyclic interruptive force has a maximum force magnitude from about 10 N to about 1000 N, from about 10 N to about 500 N, from about 10 N to about 100 N, or from about 10 N to about 50 N.

In some embodiments, the cyclic interruptive force has a maximum force magnitude from above about 10 N to about 1000 N, from above about 10 N to about 500 N, from above about 10 N to about 100 N, or from above about 10 N to about 50 N.

In some embodiments, optionally in combination with any or all the various embodiments disclosed herein, the cyclic interruptive force has a frequency of above 40 Hz or of 0.1 Hz to 40 Hz.

In another aspect of the present invention, it is provided an orthodontic system, comprising

at least one cyclic interruptive force orthodontic device according and at least one static force appliances,

wherein the cyclic interruptive force orthodontic device comprises:
a base having a geometry selected to generate orthodontic force vectors to progressively reposition the teeth from the initial arrangement to an intermediate arrangement or the final arrangement,
a spring or an elastic band attached to the base,
at least one motor attached to the spring or the elastic band, and
an actuator, which is a stand-alone actuator or included in the motor,
wherein the spring or elastic band generates an orthodontic force,
wherein the motor and the actuator are capable of communication such that the actuator is capable of causing the motor to generate a cyclic interruptive force on at least one tooth in which tooth alignment is desired to facilitate movement of the tooth; and
wherein the cyclic interruptive force is co-linear or substantially co-linear with the orthodontic force vectors; and

wherein the static force appliance holds the teeth in the intermediate arrangement or the final arrangement.

In some embodiments, optionally in combination with any or all the various embodiments disclosed herein, the actuator is a micropiezo actuator. In some embodiments, optionally in combination with any or all the various embodiments disclosed herein, the micropiezo actuator is capable of:

generating a pulling force up to 5 N,

generating a pushing force up to 1,000N,

generating a strain range of about 60 μm, and

having a response time about 1 msec. or less.

In some embodiments, optionally in combination with any or all the various embodiments disclosed herein, the micropiezo actuator has a resolution about 1 nm or less.

In some embodiments, optionally in combination with any or all the various embodiments disclosed herein, the actuator comprises a microprocessor, which allows the cyclic interruptive force orthodontic device to generate a cyclic interruptive force to cause the tooth to move at a prescribed amount of alignment.

In some embodiments, optionally in combination with any or all the various embodiments disclosed herein, the cyclic interruptive force orthodontic device and static appliance are removable.

The frequency and magnitude of the cyclic interruptive force generated by the cyclic interruptive orthodontic device disclosed herein are such that the force vibration is outside the range for human hearing via bone conduction (for night time wear). In some embodiments, such interruptive force can have vibrations of frequency and magnitude that can be inside the human hearing range for day time wear.

In some embodiments, optionally in combination with any or all the various embodiments disclosed herein, the cyclic interruptive force has a frequency of 0.1 Hz to 1000 Hz.

In some embodiments, optionally in combination with any or all the various embodiments disclosed herein, the net of the orthodontic force and the cyclic interruptive force has a maximum magnitude derived by the spring, and the minimum force magnitude is controlled by spring minus the force of the motor. In some embodiments, the cyclic interruptive force has a maximum force magnitude from about 0.1 N to about 1000 N, from about 0.1 N to about 500 N, from about 0.1 N to about 100 N, from about 0.1 N to about 50 N, from about 0.1 N to about 10 N, from about 0.1 N to about 5 N, from about 0.1 N to about 4 N, from about 0.1 N to about 3 N, from about 0.1 N to about 2 N, or from 0.1 N to about 1 N.

In some embodiments, the cyclic interruptive force has a maximum force magnitude from about 1 N to about 1000 N, from about 1 N to about 500 N, from about 1 N to about 100 N, from about 1 N to about 50 N, from about 1 N to about 10 N, from about 1 N to about 5 N, from about 1 N to about 4 N, from about 1 N to about 3 N, or from about 1 N to about 2 N.

In some embodiments, the cyclic interruptive force has a maximum force magnitude from about 2 N to about 1000 N, from about 2 N to about 500 N, from about 2 N to about 100 N, from about 2 N to about 50 N, from about 2 N to about 10 N, from about 2 N to about 5 N, from about 2 N to about 4 N, or from about 2 N to about 3 N.

In some embodiments, the cyclic interruptive force has a maximum force magnitude from about 3 N to about 1000 N, from about 3 N to about 500 N, from about 3 N to about 100 N, from about 3 N to about 50 N, from about 3 N to about 10 N, from about 3 N to about 5 N, or from about 3 N to about 4 N.

In some embodiments, the cyclic interruptive force has a maximum force magnitude from about 4 N to about 1000 N, from about 4 N to about 500 N, from about 4 N to about 100 N, from about 4 N to about 50 N, from about 4 N to about 10 N, or from about 4 N to about 5 N.

In some embodiments, the cyclic interruptive force has a maximum force magnitude from about 5 N to about 1000 N, from about 5 N to about 500 N, from about 5 N to about 100 N, from about 5 N to about 50 N, or from about 5 N to about 10 N.

In some embodiments, the cyclic interruptive force has a maximum force magnitude from about 10 N to about 1000 N, from about 10 N to about 500 N, from about 10 N to about 100 N, or from about 10 N to about 50 N.

In some embodiments, the cyclic interruptive force has a maximum force magnitude from above about 10 N to about 1000 N, from above about 10 N to about 500 N, from above about 10 N to about 100 N, or from above about 10 N to about 50 N.

In some embodiments, optionally in combination with any or all the various embodiments disclosed herein, the cyclic interruptive force has a frequency of above 40 Hz or a frequency of about 0.1 Hz to 40 Hz.

In a further aspect of the present invention, it is provided a method of aligning tooth in a subject, comprising:

applying cyclical forces to at least one tooth of the mammal in which tooth realignment is desired with a peak magnitude of about 0.1 to about 10 N and a frequency of about 0.1 to 1000 Hz in a direction of the desired realignment repeatedly for a period of time until a predetermined amount of tooth realignment is obtained,

applying a static force to hold the tooth in an aligned position when the cyclic interruptive forces are removed from the tooth.

In some embodiments, optionally in combination with any or all the various embodiments disclosed herein, the cyclic interruptive forces are repeatedly applied a plurality of times or continuously for a period each day.

In some embodiments, optionally in combination with any or all the various embodiments disclosed herein, the cyclic interruptive forces have a frequency of above 40 Hz to 1000 Hz or a frequency of about 0.1 Hz to 40 Hz.

In some embodiments, optionally in combination with any or all the various embodiments disclosed herein, the cyclic interruptive forces are repeatedly applied over a period of days or a period of months.

In some embodiments, optionally in combination with any or all the various embodiments disclosed herein, the peak magnitude is about 2 N.

In some embodiments, optionally in combination with any or all the various embodiments disclosed herein, the static force is applied by a plastic appliance.

In some embodiments, optionally in combination with any or all the various embodiments disclosed herein, the cyclic interruptive force is generated by a cyclic aligner according to any of the various embodiments disclosed herein.

In some embodiments, optionally in combination with any or all the various embodiments disclosed herein, the predetermined amount of tooth realignment and the aligned position are an intermediate tooth arrangement or a final tooth arrangement.

In some embodiments, optionally in combination with any or all the various embodiments disclosed herein, the tooth has a disorder selected from malalignment, crowding, spacing, overjet, overbite problem, and a combination thereof.

In another aspect of the present invention, it is provided a method of fabricating a cyclic interruptive force orthodontic device for repositioning teeth from an initial arrangement to a final arrangement. The device is according to the various embodiments disclosed herein.

In another aspect of the present invention, it is provided a method of fabricating for repositioning teeth from an initial arrangement to a final arrangement comprising a system comprising a cyclic interruptive force orthodontic device and a static force appliance, The system is as the various embodiments disclosed herein.

As used herein, the terms “tooth” and “teeth” are interchangeable.

As used herein, the term “appliance” refers to a removable device capable of holding tooth in an aligned position (such as an intermediate tooth arrangement or the final tooth arrangement). Such device can be a retainer type device (e.g., Hawley retainer, ASTICS™ retainer, or Essix™ retainer trays). In some embodiments, the appliance refers to a polymeric appliance, which is described below in more detail.

As used herein, the terms “align”, “realign”, “rearrange”, and “reposition” are used interchangeably.

As used herein, the terms “alignment”, “position”, “arrangement” are used interchangeably.

As used herein, the term “orthodontic device” is sometimes referred to as “aligner”.

As used herein, the terms “interruptive force” and “disruptive force” are interchangeable.

As used herein, the term “static force appliance” shall mean that an appliance of such type generates no or minimal orthodontic force; instead, such an appliance holds the tooth in its aligned position, which aligned position is achieved by the cyclic interruptive force device disclosed herein.

### Stress-Strain Related Bone Regeneration

As described in Meyer, U. et al. Biomechanical and clinical implications of distraction osteogenesis in craniofacial surgery. J Craniomaxillofac Surg 32, 140-9 (2004), bone has an adaptive behavior toward a changing mechanical environment, which is regarded as phenotype plasticity. Specific strain-dependent signals are thought to control this adaptive mode of bony tissue modeling. The adaptive mechanisms include basic multicellular units (BMUs) of bone remodeling. Effector cells within BMUs have been shown to function in an interdependent manner. While hormones may bring about as much as 10% of the postnatal changes in bone strength and mass, 40% are determined by mechanical effects. This has been shown by the loss of extremity bone mass in patients with paraplegia (more than 40%). Modeling occurs by separate formation and resorption drifts to reshape, thicken, and strengthen a bone or trabecula by moving its surfaces around in tissue space. Remodeling also involves both resorption and formation of bone. BMUs turn bone over in small packets through a process in which an activating event causes some bone resorption and bone formation is following

### Mechanotransduction of Osteoblasts

It is generally suggested that forces leading to cellular deformation are signaled to the cellular genome through mechanotransduction (Meyer, U. et al. J Craniomaxillofac Surg 32, 140-9 (2004)). Mechanotransduction, or the conversion of a biophysical force into a cellular response, is an essential mechanism in bone biology. It allows bone cells to respond to a changing mechanical environment. Mechanotransduction can be categorized in an idealized manner into (1) mechanocoupling, which means the transduction of mechanical force applied to the tissue into a local mechanical signal perceived by a bone cell; (2) biochemical coupling, the transduction of a local mechanical signal into biochemical signal cascades altering gene expression or protein activation; (3) transmission of signals from the sensor cells to effector cells, which actually form or remove bone; and ultimately (4) the effector cell response.

When loads are applied to bone, the tissue begins to deform causing local strains (typically reported in units of microstrain; 10,000 microstrain=1% change in length). It is well known that osteoblasts and osteocytes act as the sensors of local bone strains and that they are appropriately located in the bone for this function.

### In Vitro Mechanical Stimulation

The ability of living tissues to remodel in response to cyclic loads suggests that similar adaptive processes may occur in engineered tissues in vitro. Since the early work of Glucksmann in 1939 (Glucksmann A. Anatomical Record 73:39-56 (1939)), a vast array of stimulation devices have been constructed to load cells in compression, tension, bending, out-of-plane distension, in-plane distention, shear, and combinations of the above (recently reviewed by Brown). A number of studies have shown that mechanically challenged tissue constructs show hypertrophy and increased orientation of fibers and cells in comparison to control constructs. Fink et al subjected cells in a collagen gel to cyclic stretch at 1.5 Hz and observed significant changes in cell arrangement into parallel arrays, increases in cell length and width, and increases in myochondrial density. Functionally, the tissue had a contractile force 2-4 times that of the control (Fink, C; et al., Faseb Journal 14(5):669-79 (2000)). Buschmann et al found increased extracellular matrix biosynthesis in collagenous tissues by subjecting chondrocytes in an agarose gel to 3% strain at 0.01-1.0 Hz (Buschmann, Md.; et al., Journal of Cell Science, 108 (Pt 4):1497-508 (1995)). Zeichen et al found increased cell proliferation by cyclically stretching the cells 5% strain (50,000 microstrains) at 1 Hz for 15-60 minutes (Zeichen, J; et al., American Journal of Sports Medicine 2000 November-December, 28(6):888-92). Similarly, Desrosiers et al reported significant increase in cell proliferation, collagen synthesis, and proteoglycan synthesis by 10% strain (100,000 microstrains) at 0.1 Hz for 24 hours on an elastomeric substrate and (Desrosiers, E. A., et al., Ann. Chir 49, 768-774 (1995)).

### High Frequency Effects

It has long been known that low strain, high frequency stimulation (e.g. 50με @ 30 Hz) can induce similar (Qin, Y. X., et al., J. Orthop. Res. 16, 482-489 (1998)), if not more (Hsieh Y. F. and Turner C. H., Journal of Bone and Mineral Research 16:918-924 (2001)), stimulatory effects than high strain low frequency (e.g. 1,000με @ 1 Hz). Recently, Rubin et al. uncovered evidence that brief applications (e.g. 10 minutes) of barely perceptible vibrations at high frequencies (e.g. 0.25 g @ 90 Hz) stimulated bone growth better than weight-bearing activity for the same duration (Rubin C, et al., FASEB J. 15(12):2225-9). Osteoblast response to low frequency, high loads has been shown (Tanaka, S. M., et al., Journal of Biomechanics, 36(1):73-80 (2003)) to be sensitized by high frequency (50 Hz), low amplitude signals through a phenomenon termed stochastic resonance which has been reported by Collins et al. (Collins J. J., Imhoff T. T. and Grigg P. Noise-enhanced tactile sensation. Nature 1996, 383:770) to enhance the sensitivity of mechanoreceptors.

### Tooth Repositioning

Static Force Systems

Continuously applied static forces have been studied and/or used in previous studies and clinical practice in orthodontics. Continuously applied static forces are used on a daily basis for orthodontic tooth movement in these patients. Day-to-day practice of application of continuously applied static forces in clinical orthodontics, orthodontic tooth movement has been simulated in animal models with elastics and coil springs (Reitan, Acta Odont. Scand. Suppl., 6:1-240 (1951); Storey et al., (1952) Aust. J. Dent., 56:11-18; Pygh et al., (1982) In Berkivitz et al. (Eds) The Periodontal Ligament in Health and Disease, Pergamon Press, Oxford, England, pp. 269-290; Jager et al., (1993) Histochemistry, 100:161-166; Ashizawa et al., (1998) Arch Oral Biol., 43(6):473-484; Gu et al., (1999 Angle Orthod. 69(6):515-522; Melsen (1999) Angle Orthod., 69(2):151-158; Terai et al., (1999) J. Bone Miner. Res., 14(6): 839-849; Tsay et al., (1999) Am. J. Orthod. Dentofacial Orthop., 115(3):323-330; and Verna (1999) Bone, 24(4):371-379].

Threshold force and the duration of force application are two fundamental concepts in the art of orthodontics. A minimum of 6 hours was proposed to be the threshold below which orthodontic tooth movement does not occur (Proffit et al., Mosby Year Book St. Louis. pp. 266-288 (1993)). However, this projected minimum threshold of 6 hours per day by Proffit et al. is largely theoretical, as stated in the caption of FIGS. 9-12 on page 275 of that work. Empirical clinical experience appears to support the notion that orthodontic forces must be applied beyond certain daily duration in order to induce tooth movement, the precise minimum daily duration is unclear. What appears of more significance than daily minimum duration is the overall duration of orthodontic treatment in association with current technology.

The precise threshold force magnitude required for tooth movement has not yet to be determined. In general a few hundred grams of force have been implicated to be the threshold for tooth movement. However, there remain projections as “theoretically, there is no doubt that light continuous forces produce the most efficient tooth movement” [Proffit et al., (1993) Mosby Year Book: St. Louis. pp. 266-288]. It has been shown that proliferation of periodontal ligament cells is greater in response to continuous forces than to intermittent forces of the same magnitude (Reitan, Acta Odont. Scand. Suppl., 6:1-240 (1951). These intermittent forces were static forces applied intermittently over time (Reitan, 1951, supra; van Leeuwen et al., Eur. J. Oral Sci., 107(6):468-474 (1999)).

Non-Static Forces

Intermittent forces were used in orthodontic treatment of malocclusion. The nature of the intermittent forces was static forces applied intermittently over time, for instance, two hours on and two hours off (Reitan, 1951, supra; van Leeuwen et al., (1999) Eur. J. Oral Sci., 107(6):468-474). Cyclic interruptive force systems were also described in U.S. Pat. Nos. 6,648,639 and 6,832,912 to Mao et al. However, the cyclic interruptive force systems are impractical to use. A cyclic interruptive force system using cyclic interruptive forces generated by a motor for treating tooth malocclusion is described U.S. Pat. Nos. 6,832,912 and 6,648,639, the teachings of which are incorporated herein by reference.

Biomechanical and biochemical observations related to bone formation or bone absorption pertaining to tooth movement are further described in Mao, J. Dent. Res. 81(12):810-816 (2002); Vico et al., Lancet, 355(9215):1607-1611 (2000), Pavalko et al., J. Cell Biochem. 2003; 88(1):104-12; and Brown, T. D., J. of Biomechanics 33(1):3-14 (2000). The teachings in these references are incorporated herein in their entirety by reference.

### Cyclic Interruptive Force Devices

The cyclic interruptive force orthodontic device disclosed herein can have any design, as long as they are in a form suitable as orthodontic aligners. The device generally includes the various components described above. Each of the components is commercially available or can be readily constructed or made by a person of ordinary skill in the art.

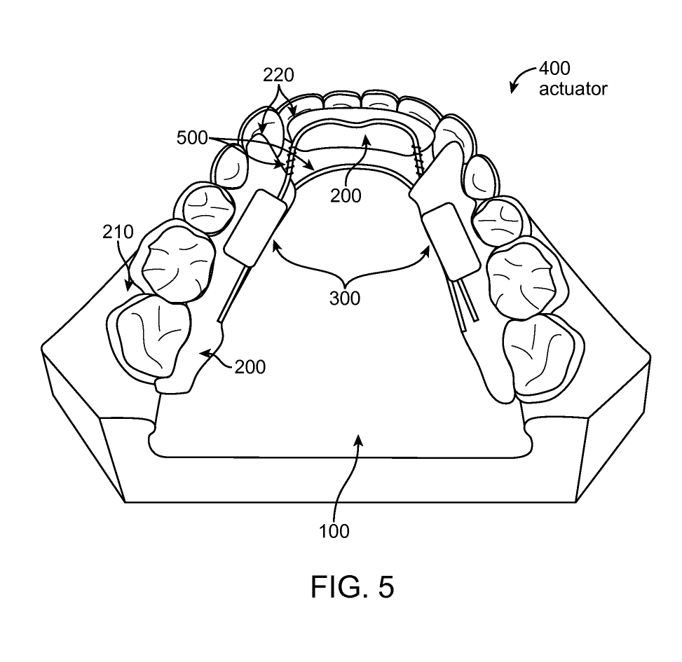

FIG. 5 shows an embodiment of the present invention. A cyclic interruptive force orthodontic device 100 includes:

a base 200 having invisible polymeric shells 210 (outside part) for receiving teeth and an interior part 220; the polymeric shells 210 and the interior part 220 having a geometry for receiving teeth,

two motors 300,

an actuator 400, which is not shown and can be included in motors 300 or as a stand alone actuator, and

springs 500.

In the device of FIG. 5, the interior part 220 consists of three sub-parts, which are connected by springs 500. In application, springs 500 generates an orthodontic force, and actuator 400 can work with motors 300 to generate cyclic interruptive forces and cause, through springs 500, the orthodontic device 100 to exert such cyclic interruptive forces on the teeth.

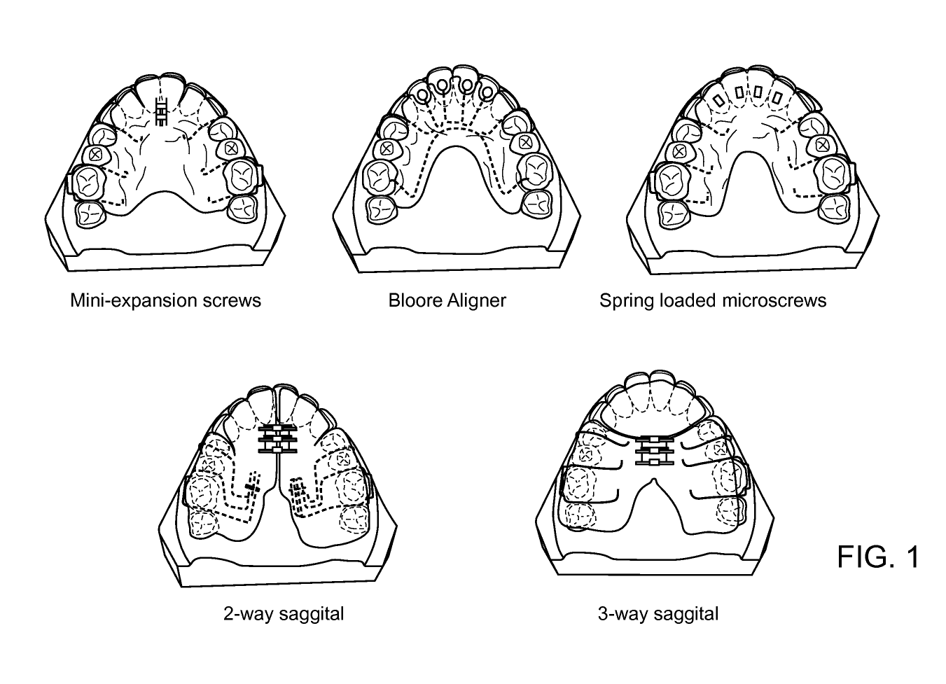

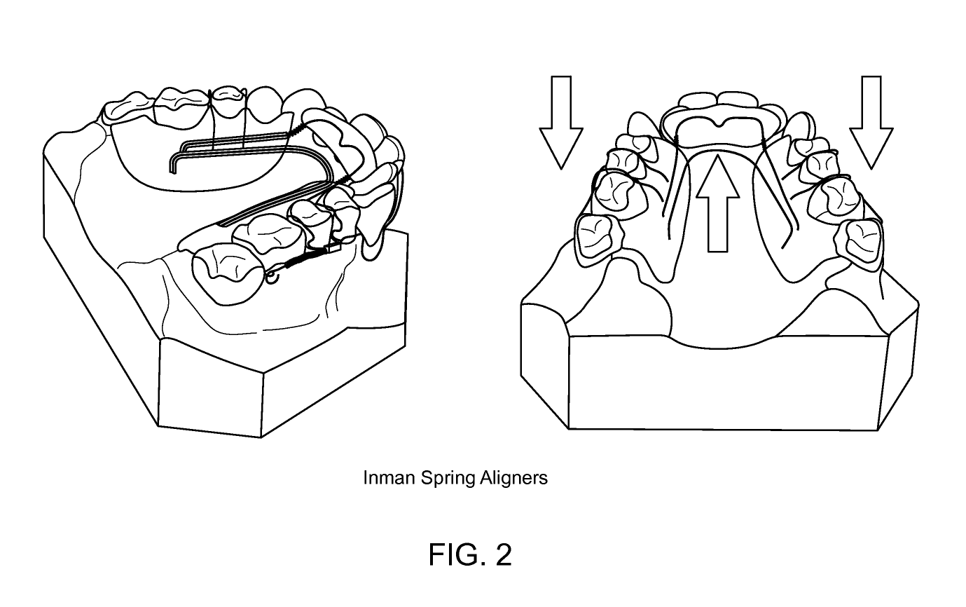

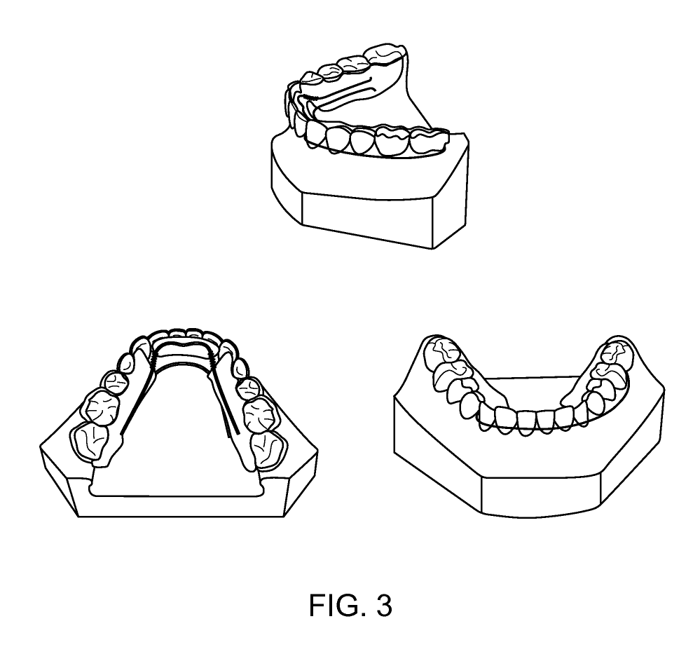

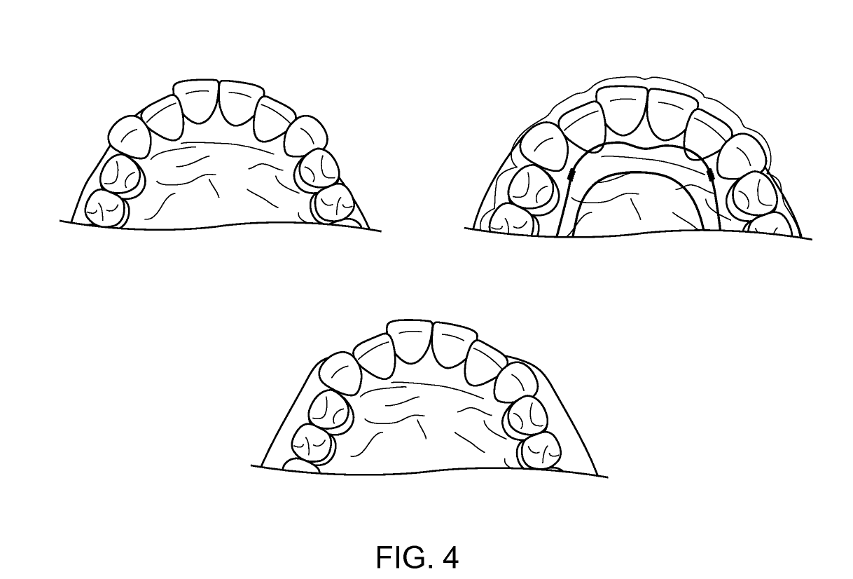

According to the descriptions above and below, conventional aligners, such as those shown in FIGS. 1-4, can be readily modified so as to form a cyclic interruptive force device as described herein.

In some embodiments, the cyclic interruptive force device can be a manual, eco-friendly version where a disruptive force is generated each time the patient bites down.

In some embodiments, the cyclic interruptive force device can include button(s) to facilitate repositioning of teeth.

The cyclic interruptive force device can be designed and formed by established methods of computer-aided fabrication. Generally, such methods generally include:

obtaining a digital data set representing the initial tooth arrangement of one or more teeth,

generating a digital image representing the initial tooth arrangement,

moving one or more teeth in the digital image representing the initial tooth arrangement to generate a digital image representing a final tooth arrangement,

moving one or more teeth in the digital image representing the initial tooth arrangement or the digital image representing a final tooth arrangement to generate one or more digital images representing one or more intermediate tooth arrangements, the one or more intermediate tooth arrangements represent one or more tooth positions between the initial tooth arrangement and the final tooth arrangements as judged proper by an orthodontic practitioner,

fabricating one or more cyclic interruptive force retainer capable of moving teeth
from the initial tooth arrangement to one sub-intermediate arrangement;
from one sub-intermediate arrangement to a successive sub-intermediate arrangement to the final tooth arrangement; or
from one sub-intermediate arrangement to the final arrangement.

As used herein, the term sub-intermediate arrangement refers to one intermediate tooth arrangement of two or more intermediate tooth arrangements.

Computer-aided fabrication of tooth aligners are well documented in the art. For example, For example, Kuroda et al. (1996) Am. J. Orthodontics 110:365-369 describes a method for laser scanning a plaster dental cast to produce a digital image of the cast. See also U.S. Pat. No. 5,605,459. U.S. Pat. Nos. 5,533,895; 5,474,448; 5,454,717; 5,447,432; 5,431,562; 5,395,238; 5,368,478; and 5,139,419, assigned to Ormco Corporation, describe methods for manipulating digital images of teeth for designing orthodontic devices.

U.S. Pat. No. 5,011,405 describes a method for digitally imaging a tooth and determining optimum bracket positioning for orthodontic treatment. Laser scanning of a molded tooth to produce a three-dimensional model is described in U.S. Pat. No. 5,338,198. U.S. Pat. No. 5,452,219 describes a method for laser scanning a tooth model and milling a tooth mold. Digital computer manipulation of tooth contours is described in U.S. Pat. Nos. 5,607,305 and 5,587,912. Computerized digital imaging of the jaw is described in U.S. Pat. Nos. 5,342,202 and 5,340,309. Other patents of interest include U.S. Pat. Nos. 5,549,476; 5,382,164; 5,273,429; 4,936,862; 3,860,803; 3,660,900; 5,645,421; 5,055,039; 4,798,534; 4,856,991; 5,035,613; 5,059,118; 5,186,623; and 4,755,139.

The teachings in the above references are incorporated herein in their entirety by reference.

The computer-aided fabrication methods allows one to form the base component of the cyclic interruptive force device. Other components, such as the spring or elastic band, motor, and actuator can be readily attached to the base or otherwise assembled by a person of ordinary skill in the art to form the cyclic interruptive force device.

Motors

As used herein, motors refer to mini or micro motors capable of imparting cyclic interruptive forces defined above to the orthodontic device of the various embodiments described herein. Such motors are commercially available, which can be readily modified by a person of ordinary skill in the art for the intended use in the present invention.

In some embodiments, the motor can include a power source, which can be a battery. The battery can be included in the motor or otherwise included in the base of the cyclic interruptive force device.

A few other embodiments of the motors useful in the present invention are described in U.S. Pat. Nos. 6,648,639 and 6,832,912, the teachings of which are incorporated herein in their entirety by reference.

Actuators

Actuators useful for the cyclic interruptive force device descried herein can be a mini-size, microsize, or regular size actuators, as long as a cyclic interruptive force device having such an actuator can be formed and used for orthodontic use. In some embodiments, the actuator can include a microprocessor. The microprocessor allows for preprogramming so as to cause the cyclic interruptive force orthodontic device to provide cyclic interruptive forces to achieve tooth realignment or repositioning of the various embodiments disclosed herein.

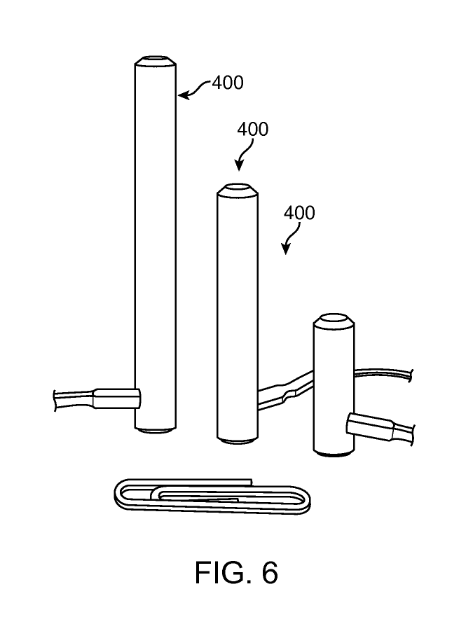

Such actuators are commercially available, which can be readily modified by a person of ordinary skill in the art for the intended use in the present invention. FIG. 6 shows some examples of actuators suitable for use in the present invention.

A few other embodiments of the actuators useful in the present invention are described in U.S. Pat. Nos. 6,648,639 and 6,832,912, the teachings of which are incorporated herein in their entirety by reference.

### Static Force Appliances

The appliances disclosed herein are intended for use to hold teeth in the one or more intermediate tooth arrangements or the final tooth arrangements, which are described in the description of cyclic interruptive force retainers and more above. These appliances provide little or no aligning force, as compared to an aligning force generated by the cyclic interruptive force retainer, described above. The relative aligning force between an cyclic interruptive force retainer and an appliance can be determined by the mechanical force of the materials forming the cyclic interruptive force retainer (e.g., metallic wire, spring, or a relatively harder plastic material) and the polymer forming the appliance.

Polymeric orthodontic appliances are well known in the art, the fabrication of which is well described in, e.g., U.S. Pat. Nos. 6,398,548 and 6,554,611. The teachings in these documents are incorporated herein in their entirety by reference.

### Method of Using

According to a method of the present invention, a user's teeth are repositioned from an initial tooth arrangement to a final tooth arrangement by placing a series of incremental position adjustment cyclic interruptive force retainers in the user's mouth. Conveniently, the cyclic interruptive force retainers are not affixed and the user may place and replace the cyclic interruptive force retainers at any time during the procedure. The first cyclic interruptive force retainer of the system will have a geometry selected to reposition the teeth from the initial tooth arrangement to a first intermediate arrangement. After the first intermediate arrangement is approached or achieved, one or more additional (intermediate cyclic interruptive force retainers) will be successively placed on the teeth, where such additional cyclic interruptive force retainers have geometries selected to progressively reposition teeth from the first intermediate arrangement through successive intermediate arrangement(s). The treatment will be finished by placing a final appliance in the user's mouth, where the final cyclic interruptive force retainer has a geometry selected to progressively reposition teeth from the last intermediate arrangement to the final tooth arrangement. The final cyclic interruptive force retainer or several cyclic interruptive force retainers in the system may have a geometry or geometries selected to over correct the tooth arrangement, i.e. have a geometry which would (if fully achieved) move individual teeth beyond the tooth arrangement which has been selected as the “final.” Such over correction may be desirable in order to offset potential relapse after the repositioning method has been terminated, i.e. to permit some movement of individual teeth back toward their pre-corrected positions. Over correction may also be beneficial to speed the rate of correction, i.e. by having an cyclic interruptive force retainer with a geometry that is positioned beyond a desired intermediate or final position, the individual teeth will be shifted toward the position at a greater rate. In such cases, treatment can be terminated before the teeth reach the positions defined by the final cyclic interruptive force retainer or cyclic interruptive force retainers.

The cyclic interruptive force retainers can be used in the day time or night time. In some embodiments, it is used in the night.

Appliances can be used to hold teeth in an intermediate arrangement or a final tooth arrangement, described above. The appliances can be used in the day time or night time. In some embodiments, it is used in the day time.

The system can be used to treat or prevent orthodontic conditions such as malalignment, crowding, spacing, overjet, overbite problem, and a combination thereof.

While the above is a complete description of the preferred embodiments of the invention, various alternatives, modifications, and equivalents may be used. Therefore, the above description should not be taken as limiting the scope of the invention which is defined by the appended claims.

1. A cyclic interruptive force orthodontic device for repositioning teeth from an initial arrangement to a final arrangement, comprising:
a base having a geometry selected to generate orthodontic force vectors to progressively reposition the teeth from the initial arrangement to an intermediate arrangement or the final arrangement,
a spring or an elastic band attached to the base,
at least one motor attached to the spring or the elastic band, and
an actuator, which is a stand-alone actuator or included in the motor,
wherein the spring or elastic band generates an orthodontic force,
wherein the motor and the actuator are capable of communication such that the actuator is capable of causing the motor to generate a cyclic interruptive force on at least one tooth in which tooth alignment is desired to facilitate movement of the tooth; and
wherein the cyclic interruptive force is co-linear or substantially co-linear with the orthodontic force vectors.

2. The cyclic interruptive force orthodontic device of claim 1, wherein the actuator is a micropiezo actuator.

3. The cyclic interruptive force orthodontic device of claim 2, wherein the micropiezo actuator is capable of:
generating a pulling force up to 5 N,
generating a pushing force up to 1,000N,
generating a strain range of about 60 μm, and
having a response time about 1 msec. or less.

4. The cyclic interruptive force orthodontic device of claim 3, wherein the micropiezo actuator has a resolution about 1 nm or less.

5. The cyclic interruptive force orthodontic device of claim 1, wherein the actuator comprises a microprocessor, which allows the cyclic interruptive force orthodontic device to generate a cyclic interruptive force to cause the tooth to move at a prescribed amount of alignment.

6. The cyclic interruptive force orthodontic device of claim 1, which is removable.

7. The cyclic interruptive force orthodontic device of claim 1, wherein the cyclic interruptive force has a frequency of 0.1 Hz to 1000 Hz.

8. The cyclic interruptive force orthodontic device of claim 1, wherein the cyclic interruptive force has a peak magnitude up to 1000 N.

9. The cyclic interruptive force orthodontic device of claim 1, wherein the cyclic interruptive force has a frequency of above 40 Hz or of 0.1 Hz to 40 Hz.

10. An orthodontic system, comprising
at least one cyclic interruptive force orthodontic device according and at least one static force appliances,
wherein the cyclic interruptive force orthodontic device comprises:
a base having a geometry selected to generate orthodontic force vectors to progressively reposition the teeth from the initial arrangement to an intermediate arrangement or the final arrangement,
a spring or an elastic band attached to the base,
at least one motor attached to the spring or the elastic band, and
an actuator, which is a stand-alone actuator or included in the motor,
wherein the spring or elastic band generates an orthodontic force,
wherein the motor and the actuator are capable of communication such that the actuator is capable of causing the motor to generate a cyclic interruptive force on at least one tooth in which tooth alignment is desired to facilitate movement of the tooth; and
wherein the cyclic interruptive force is co-linear or substantially co-linear with the orthodontic force vectors; and
wherein the static force appliance holds the teeth in the intermediate arrangement or the final arrangement.

11. The system of claim 10, wherein the actuator is a micropiezo actuator.

12. The system of claim 11, wherein the micropiezo actuator is capable of:
generating a pulling force up to 5 N,
generating a pushing force up to 1,000N,
generating a strain range of about 60 μm, and
having a response time about 1 msec. or less.

13. The system of claim 12, wherein the micropiezo actuator has a resolution about 1 nm or less.

14. The system of claim 10, wherein the actuator comprises a microprocessor, which allows the cyclic interruptive force orthodontic device to generate a cyclic interruptive force to cause the tooth to move at a prescribed amount of alignment.

15. The system of claim 10, which is removable.

16. The system of claim 10, wherein the cyclic interruptive force has a frequency of 0.1 Hz to 1000 Hz.

17. The system of claim 10, wherein the cyclic interruptive force has a peak magnitude up to 1000 N.

18. The system of claim 10, wherein the cyclic interruptive force has a frequency of above 40 Hz.

19. A method of aligning tooth in a subject, comprising:
applying an orthodontic force and a cyclical interruptive force to at least one tooth of the mammal in which tooth realignment is desired wherein the net of the orthodontic force and the cyclic interruptive force has a maximum magnitude of about 0.1 to about 1000 N and a frequency of about 0.1 to 1000 Hz in a direction of the desired realignment repeatedly for a period of time until a predetermined amount of tooth realignment is obtained,
applying a static force to hold the tooth in an aligned position when the cyclic interruptive forces are removed from the tooth.

20. The method according to claim 19 wherein the cyclic interruptive forces are repeatedly applied a plurality of times or continuously for a period each day.

21. The method of claim 19, wherein the cyclic interruptive forces have a frequency of above 40 Hz to 1000 Hz or a frequency of about 0.1 Hz to 40 Hz.

22. The method of claim 20 wherein the cyclic interruptive forces are repeatedly applied over a period of days or a period of months.

23. The method of claim 19 wherein the peak magnitude is about 2 N.

24. The method of claim 19, wherein the static force is applied by a plastic appliance.

25. The method of claim 19, wherein the cyclic interruptive force is generated by a cyclic interruptive force device for repositioning teeth from an initial arrangement to a final arrangement, comprising:
a base having a geometry selected to generate orthodontic force vectors to progressively reposition the teeth from the initial arrangement to an intermediate arrangement or the final arrangement,
a spring or an elastic band attached to the base,
at least one motor attached to the spring or the elastic band, and
an actuator, which is a stand-alone actuator or included in the motor,
wherein the spring or elastic band generates an orthodontic force,
wherein the motor and the actuator are capable of communication such that the actuator is capable of causing the motor to generate a cyclic interruptive force on at least one tooth in which tooth alignment is desired to facilitate movement of the tooth; and
wherein the cyclic interruptive force is co-linear or substantially co-linear with the orthodontic force vectors.

26. The method of claim 25, wherein the predetermined amount of tooth realignment and the aligned position are an intermediate tooth arrangement or a final tooth arrangement.

27. The method of claim 26, wherein the tooth has a disorder selected from the group consisting of malalignment, crowding, spacing, overjet, overbite problem, and a combination thereof.
